(19) United States
(12) Patent Application Publication
(10) Pub. No.: US 2021/0125162 A1
(43) Pub. Date: Apr. 29, 2021

(54) FLEXIBLE PARKING SPACE PAYMENT

(71) Applicant: Virtual OnQ Systems, LLC, Plantation, FL (US)

(72) Inventor: Gokhan Gulec, Plantation, FL (US)

(21) Appl. No.: 16/661,996

(22) Filed: Oct. 23, 2019

(51) Int. Cl. G06Q 20/10; G06Q 20/32; G06Q 20/38; G06Q 20/22; H04W 4/14

(52) U.S. Cl. CPC G06Q 20/102; G06Q 20/3223; G06Q 20/385; G06F 16/9558; G06Q 20/3255; H04W 4/14; G06Q 20/227

(57) ABSTRACT

In a method, system and computer program product for flexible parking space payment, a text message is received from a mobile computing device and parking location information extracted therefrom, along with a phone number for the mobile computing device. Thereafter, a reply message is transmitted to the phone number, that encapsulates a hyperlink to a Web application adapted upon request to render in the mobile computing device a user interface prompting for a license plate, a specified duration of time, and mode of payment information to pay a parking fee computed based upon the parking location information and specified duration of time. In response to receiving a submission in the user interface of the license plate, specified duration of time, and mode of payment information, payment of the parking fee is directed with the mode of payment.

### BACKGROUND OF THE INVENTION

### Field of the Invention

The present invention relates to the field of parking meters and more particularly to remote payment systems for parking meters.

### Description of the Related Art

A parking meter is a device used to collect money in exchange for the right to park a vehicle in a particular place for a limited amount of time. Traditional parking meters are single space meters, each corresponding to a single parking space. Traditional, single space meters accept coins in exchange for a set period of time before the single space meter indicates an expiration condition. More recent parking meters are multi-space meters addressing multiple parking spaces. Yet the principle remains the same. The customer provides currency or credit card payment to the physical meter in exchange for a right to park in a parking space for a specified duration of time and when that time expires, a visual indication is provided so that parking enforcement may issue a parking ticket.

Of note, modern renditions of the parking meter permit Internet activation. In this regard, Internet enabled parking meters permit an end user to access a Web site or mobile application, identify a parking space of interest and submit credit card payment. Indeed, the modern parking meeting meter may even transmit a message to the end user reminding the end user to apply additional funds to avoid an expiration condition. Even still, the flexibility afforded by the modern parking meter is not without its deficiencies. Most significantly, the modern parking meter still requires the end user to interact with a proprietary computing application installed in a smart phone, and to store in a remote location, payment information, neither of which is desirable in an era of data privacy.

### BRIEF SUMMARY OF THE INVENTION

Embodiments of the present invention address deficiencies of the art in respect to parking space payments and provide a novel and non-obvious method, system and computer program product for flexible parking space payment. In an embodiment of the invention, a method for supporting flexible parking space payments includes receiving a text message from a mobile computing device and extracting therefrom, parking location information and also a phone number for the mobile computing device. Thereafter, a reply message is transmitted to the phone number, the reply message encapsulating a hyperlink to a Web application adapted upon request to render in the mobile computing device a user interface prompting for a license plate, a specified duration of time, and mode of payment information to pay a parking fee computed based upon the parking location information and specified duration of time. In response to receiving a submission in the user interface of the license plate, specified duration of time, and mode of payment information, payment of the parking fee is directed with the mode of payment and a record is recorded in a database, the record including an indication of the license plate and time data based upon the specified duration of time. Optionally, the record may be deleted upon expiration of the specified duration of time.

In one aspect of the embodiment, the Web application is further adapted to receive in lieu of the mode of payment, a passcode and, in response to receiving the passcode, a corresponding record is located in a database, along with an associated mobile phone number and one or more authorized license plates and a pre-stored mode of payment. Then, the extracted phone number and license plate are compared to information in the corresponding record and, on condition that the extracted phone number and license plate match information in the corresponding record, the payment of the parking fee may be directed with the pre-stored mode of payment and an indication recorded in a database record of the license plate and time data based upon the specified duration of time. Optionally, the Web application may be further adapted to render in the user interface a drop-down box with a listing of all of the authorized license plates from which one of the license plates in the listing is selected as the license plate to be submitted in response to the prompting. As well, the Web application may be yet further adapted to insert into the corresponding record a license plate specified in the user interface in response to the prompting.

In another embodiment of the invention, a parking space data processing system is configured for supporting flexible parking space payment. The system includes a host computing system that includes one or more computers, each with memory and at least one processor. The system further includes a parking space payment module that has computer program instructions. The instructions are adapted to perform during execution in the host computing system, the receipt of a text message from a mobile computing device, the extraction from the text message parking location information and also a phone number for the mobile computing device, the transmission to the phone number of a reply message encapsulating a hyperlink to a Web application adapted upon request to render in the mobile computing device a user interface prompting for a license plate, a specified duration of time, and mode of payment information to pay a parking fee computed based upon the parking location information and specified duration of time and, in response to receiving a submission in the user interface of the license plate, specified duration of time, and mode of payment information, the direction of a payment of the parking fee with the mode of payment and recording in a database record an indication of the license plate and time data based upon the specified duration of time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for flexible parking space payment;

FIG. 2 is a schematic illustration of a data processing system configured for flexible parking space payment; and,

FIG. 3 is a flow chart illustrating a process for flexible parking space payment.

### DETAILED DESCRIPTION OF THE INVENTION

Embodiments of the invention provide for flexible parking space payment. In accordance with an embodiment of the invention, an end user parking a vehicle in a parking space transmits from a mobile device a text message to a phone number associated with the parking space. In response, the end user receives a reply text message that includes a hyperlink to a Web site. Upon activating the hyperlink, a Web browser launches in the mobile device and loads a Web page from the Web site at the hyperlink. The end user supplies a license plate and duration of time along with a payment method in the Web page in response to which a record is created recording the right of the end user to park in the parking space for the duration of time while the payment method is used to assess a charge for parking in the parking space. In this way, online parking meter payment can be achieved without requiring the installation of a proprietary application in the mobile device—only text messaging and a Web browser which are already included as part of the mobile device is required.

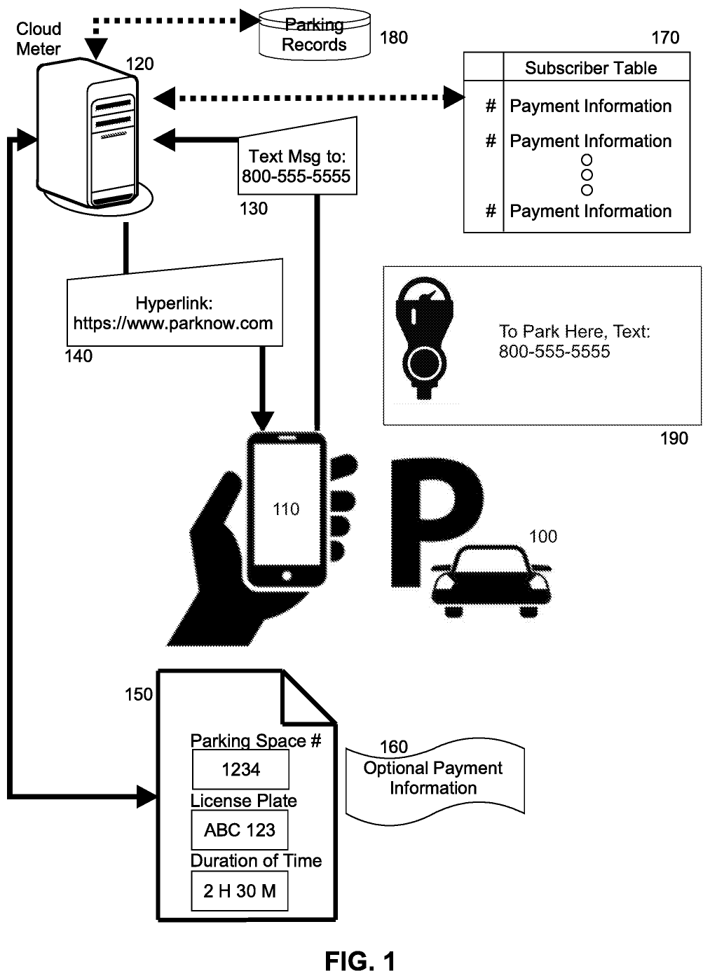

In further illustration, FIG. 1 pictorially shows a process for flexible parking space payment. As shown in FIG. 1, an end user seeking permission to park a vehicle in a parking space 100 utilizes a corresponding mobile computing device 110 to transmit a text message 130 to a message receiver in cloud meter computing system 120 at a phone number indicated by signage 190 associated with the parking space 100. Upon receipt of the text message 130, the cloud meter computing system 120 responds with a text message 140 to the mobile computing device 110 that includes therein, a uniform resource locator (URL) pointing to a Web site also operating within the cloud meter computing system 120. Upon activation of the URL, a Web browser is launched in the mobile computing device 110 and a Web page 150 associated with the URL located therein.

The Web page 150 loaded in the Web browser of the mobile computing device 110 includes at least three user interface input fields: a field in which a parking space identifier is presented, a license plate of the vehicle and a duration of time during which the vehicle is to remain stationary in the parking space 100. Optionally, the parking space identifier may be automatically completed in association with the telephone number to which the original text message 130 had been transmitted. As an additional option, payment information 160 such as a credit card number, credit card expiration date and security code may be provided through the Web page 150.

Upon receiving a submittal of the Web page 150, the cloud meter computing system 120 consults a subscriber table 170 associating the license plate with payment information. Upon retrieving a payment record from the subscriber table that corresponds to the license plate, the cloud meter computing system 120 writes a record to parking records database 180 indicating permission for the vehicle to remain in the parking space 100 for the specified duration of time. Optionally, on the condition that a payment record cannot be located in the subscriber table 170, a new record may be written to the subscriber table 170 associating the license plate of the Web page 150 with the optional payment information 160.

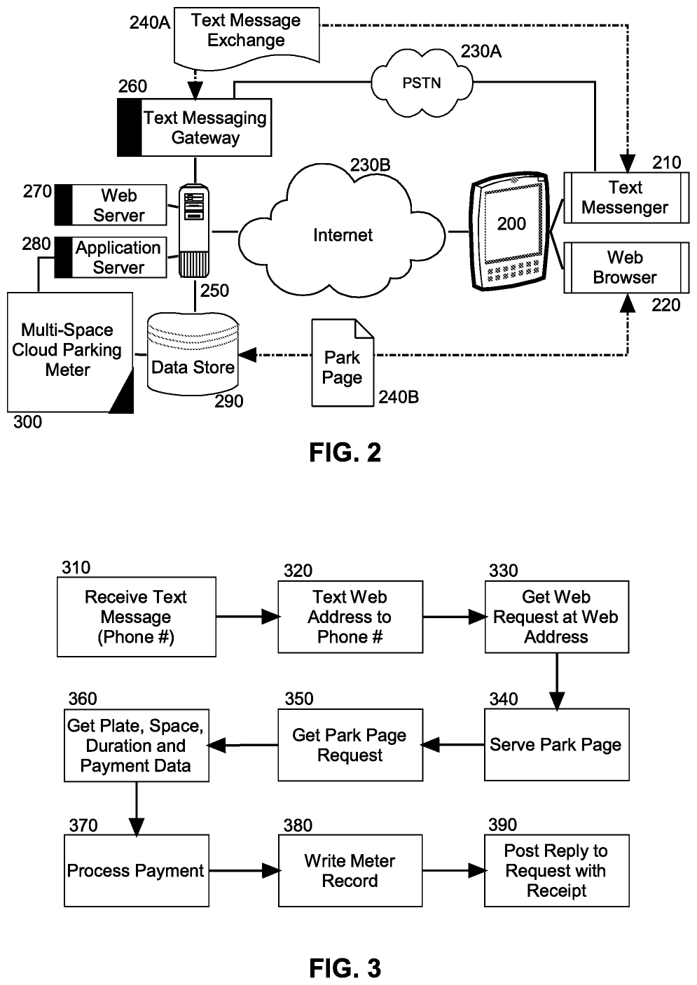

The process described in connection with FIG. 1 may be implemented in a computer data processing system. In further illustration, FIG. 2 schematically shows a data processing system configured for flexible parking space payment. The system includes a host computing system 250 that includes one or more computers, each with memory and at least one processor. A text messaging gateway 260 executes in the memory of the host computing system 250 and is operable to receive text messages 240A, e.g. short message service (SMS) messages, from a text messenger 210 in a smart phone 200 from over a public switched telephone network (PSTN) 230A, and also to transmit text messages 240A to the text messenger 210 over the PSTN 230A indicating a URL configured to retrieve a Web page 240B from Web server 270.

In this regard, the web server 270 also executes in the memory of the host computing system 250 and is operable to transmit the Web pages 240B to a Web browser 220 executing in the smart phone 200 from over a computer communications network 230B such as the Internet. As well, an application server 280 also executes in the memory of the host computing system 250 and is coupled to the Web server 270. The application server 280 manages execution therein of a multi-space cloud parking meter module 300.

The module 300 includes computer program instructions that when executing in the memory of the host computing system 250, are enabled to receive a completed Web page 240B from the Web browser 220 of the smart phone 200 including an indication of a parking space, a license plate and a duration of time. The program instructions are further enabled to respond to the receipt of the Web page 240B by locating in data store 290, an existing record for the license plate that includes an association with payment information.

The program instructions yet further are enabled upon the condition that no record is determined to exist in the data store 290, to add a record to the data store associating the license plate with payment information included in the Web page 240B. But otherwise, the program instructions are enabled to submit the payment information to a merchant accounting system for payment and to write a record in the data store 290 indicating permission for a vehicle with the license plate to remain present in the parking space for the duration of time.

In even yet further illustration of the operation of the multi-space cloud parking meter module, FIG. 3 is a flow chart illustrating a process for flexible parking space payment. Beginning in block 310, a text message is received from a text messenger of a mobile device associated with a particular phone number and in block 320, a reply text message is transmitted to the text messenger at the particular phone number including content indicative of a URL of a specific Web page. In block 330, a request is received from a Web browser in the mobile device to retrieve the Web page and in block 340, the Web page is served to the Web browser in the mobile device, the Web page including at least input fields for a license plate, parking space and duration of time.

In response to having served the Web page to the Web browser, in block 350 a response to the Web page is received including completed data for the input fields—namely the license plate, parking space and duration of time. Thereafter, in block 360 the completed data is extracted from the response and payment data retrieved from storage for the license plate. In block 370, a payment is processed in respect to the parking space and duration of time utilizing the payment data and in block 380, a record is written indicating permission for a vehicle with the license plate to park in the parking space for the duration of time. Finally, in block 390, a response is transmitted to the Web browser of the mobile device indicating a receipt for the payment. In this way, electronic meter management can be achieved without requiring the end user to install and utilize a proprietary application onto the mobile device.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for supporting flexible parking space payment comprising:
receiving a text message from a mobile computing device;
extracting from the text message parking location information and also a phone number for the mobile computing device;
transmitting to the phone number, a reply message encapsulating a hyperlink to a Web application adapted upon request to render in the mobile computing device a user interface prompting for a license plate, a specified duration of time, and mode of payment information to pay a parking fee computed based upon the parking location information and specified duration of time and, in response to receiving a submission in the user interface of the license plate, specified duration of time, and mode of payment information, directing payment of the parking fee with the mode of payment and recording in a database record an indication of the license plate and time data based upon the specified duration of time.

2. The method of claim 1, wherein the Web application is further adapted to receive in lieu of the mode of payment, a passcode and in response to receiving the passcode, locating in a database a corresponding record with associated mobile phone number and one or more authorized license plates and a pre-stored mode of payment, comparing the extracted phone number and license plate to information in the corresponding record and, on condition that the extracted phone number and license plate matches information in the corresponding record, directing the payment of the parking fee with the pre-stored mode of payment and recording in a database record an indication of the license plate and time data based upon the specified duration of time.

3. The method of claim 1, further comprising deleting the record upon expiration of the specified duration of time.

4. The method of claim 2, wherein the Web application is further adapted to render in the user interface a drop-down box with a listing of all of the authorized license plates from which one of the license plates in the listing is selected as the license plate to be submitted in response to the prompting.

5. The method of claim 2, wherein the Web application is further adapted to insert into the corresponding record a license plate specified in the user interface in response to the prompting.

6. A parking space data processing system configured for supporting flexible parking space payment, the system comprising:
a host computing system comprising one or more computers, each with memory and at least one processor;
a parking space payment module comprising computer program instructions adapted during execution in the host computing system to perform:
receiving a text message from a mobile computing device;
extracting from the text message parking location information and also a phone number for the mobile computing device;
transmitting to the phone number, a reply message encapsulating a hyperlink to a Web application adapted upon request to render in the mobile computing device a user interface prompting for a license plate, a specified duration of time, and mode of payment information to pay a parking fee computed based upon the parking location information and specified duration of time and, in response to receiving a submission in the user interface of the license plate, specified duration of time, and mode of payment information, directing payment of the parking fee with the mode of payment and recording in a database record an indication of the license plate and time data based upon the specified duration of time.

7. The system of claim 6, wherein the Web application is further adapted to receive in lieu of the mode of payment, a passcode and in response to receiving the passcode, locating in a database a corresponding record with associated mobile phone number and one or more authorized license plates and a pre-stored mode of payment, comparing the extracted phone number and license plate to information in the corresponding record and, on condition that the extracted phone number and license plate matches information in the corresponding record, directing the payment of the parking fee with the pre-stored mode of payment and recording in a database record an indication of the license plate and time data based upon the specified duration of time.

8. The system of claim 6, where the program instructions further perform deleting the record upon expiration of the specified duration of time.

9. The system of claim 7, wherein the Web application is further adapted to render in the user interface a drop-down box with a listing of all of the authorized license plates from which one of the license plates in the listing is selected as the license plate to be submitted in response to the prompting.

10. The system of claim 7, wherein the Web application is further adapted to insert into the corresponding record a license plate specified in the user interface in response to the prompting.

11. A computer program product for supporting flexible parking space payment, the computer program product including a computer readable storage medium having program instructions embodied therewith, the program instructions executable by a device to cause the device to perform a method including:
receiving a text message from a mobile computing device;
extracting from the text message parking location information and also a phone number for the mobile computing device;
transmitting to the phone number, a reply message encapsulating a hyperlink to a Web application adapted upon request to render in the mobile computing device a user interface prompting for a license plate, a specified duration of time, and mode of payment information to pay a parking fee computed based upon the parking location information and specified duration of time and, in response to receiving a submission in the user interface of the license plate, specified duration of time, and mode of payment information, directing payment of the parking fee with the mode of payment and recording in a database record an indication of the license plate and time data based upon the specified duration of time.

12. The computer program product of claim 11, wherein the Web application is further adapted to receive in lieu of the mode of payment, a passcode and in response to receiving the passcode, locating in a database a corresponding record with associated mobile phone number and one or more authorized license plates and a pre-stored mode of payment, comparing the extracted phone number and license plate to information in the corresponding record and, on condition that the extracted phone number and license plate matches information in the corresponding record, directing the payment of the parking fee with the pre-stored mode of payment and recording in a database record an indication of the license plate and time data based upon the specified duration of time.

13. The computer program product of claim 11, wherein the method further includes deleting the record upon expiration of the specified duration of time.

14. The computer program product of claim 12, wherein the Web application is further adapted to render in the user interface a drop-down box with a listing of all of the authorized license plates from which one of the license plates in the listing is selected as the license plate to be submitted in response to the prompting.

15. The computer program product of claim 12, wherein the Web application is further adapted to insert into the corresponding record a license plate specified in the user interface in response to the prompting.
